(19) United States
(12) Patent Application Publication
(10) Pub. No.: US 2025/0191852 A1
(43) Pub. Date: Jun. 12, 2025

(54) SOLID ELECTROLYTIC CAPACITOR AND PRODUCTION METHOD FOR SOLID ELECTROLYTIC CAPACITOR

(71) Applicant: Panasonic Intellectual Property Management Co., Ltd., Osaka (JP)

(72) Inventors: Kenji KURANUKI, KYOTO FU (JP); Junichi KURITA, OSAKA FU (JP); Daisuke KUBO, OSAKA FU (JP)

(21) Appl. No.: 19/056,453

(22) Filed: Feb. 18, 2025

Related U.S. Application Data
(63) Continuation of application No. PCT/JP2023/030352, filed on Aug. 23, 2023.

(30) Foreign Application Priority Data
Aug. 24, 2022 (JP) 2022-133368

(51) Int. Cl. H01G 9/052; H01G 9/00; H01G 9/045; H01G 9/15

(52) U.S. Cl. CPC H01G 9/052; H01G 9/0029; H01G 9/15; H01G 9/045

(57) ABSTRACT

A production method is a production method for a solid electrolytic capacitor including at least one solid electrolytic capacitor element including a cathode portion and an anode portion including an anode lead-out portion. The production method includes: a step (i) of connecting one anode connecting member made of a metal that is not a valve metal to the anode lead-out portion of the at least one solid electrolytic capacitor element; a step (ii) of forming an exterior body to cover the at least one solid electrolytic capacitor element and at least a part of the anode connecting member; a step (iii) of exposing the surface of a part of the anode connecting member on the exterior body as a connecting surface by removing a part of the exterior body; and a step (iv) of connecting the anode lead terminal to the connecting surface.

### CROSS REFERENCE TO RELATED APPLICATION

The present application is a continuation application of International Application No. PCT/JP2023/030352, filed on Aug. 23, 2023, which claims the priority benefit of Japanese Patent Application No. 2022-133368, filed on Aug. 24, 2022, the entire contents of each of which are hereby incorporated herein by reference.

### TECHNICAL FIELD

The present disclosure relates to a solid electrolytic capacitor and a production method for a solid electrolytic capacitor.

### BACKGROUND

Typically, a solid electrolytic capacitor includes a solid electrolytic capacitor element, a lead terminal connected to the solid electrolytic capacitor element, and an exterior body that seals the solid electrolytic capacitor element. Various proposals have been made regarding connection between the lead terminal and the solid electrolytic capacitor element.

Japanese Unexamined Patent Application Publication (Translation of PCT Application) No. 2013-515381 discloses “a method of forming a solid electrolytic capacitor comprising: forming an anode containing a valve metal or a conductive oxide of the valve metal, an anode lead extension protruding from the anode; forming a dielectric on the anode; forming a cathode layer on the dielectric; encasing the anode, the dielectric, and the cathode layer in a non-conductive material encasement; exposing the anode lead extension at the outer side surface of the encasement; bonding a conductive metal layer to the anode lead extension; and electrically connecting a preformed solid metal terminal to the conductive metal layer on the side surface”.

Japanese Laid-Open Patent Publication No. 2008-235413 discloses “a solid electrolyte comprising: a flat plate-like element using a conductive polymer as a solid electrolyte, the element having an anode electrode part and a cathode electrode part with an insulating part interposed therebetween; an anode comb terminal that is joined with the anode electrode part provided in the flat plate-like element; a cathode comb terminal that is joined with the cathode electrode part provided in the flat plate-like element; and an insulative exterior resin covering integrally the element, the anode comb terminal, and the cathode comb terminal with the anode comb terminal and the cathode comb terminal exposed partially, wherein notches are provided on both ends of an end portion of the cathode electrode part in a direction linking the anode electrode part and the cathode electrode part of the flat plate-like element, and side wall parts to be contacted with side surfaces of the notches provided in the cathode electrode part of the element are provided by bending upward both ends of an element mounting part of the cathode comb terminal for mounting the cathode electrode part of the element”.

Japanese Laid-Open Patent Publication No. 2004-87893 discloses “a solid electrolytic capacitor comprising: capacitor elements each having an anode section formed by separating an anode body made of a valve action metal into an anode section and a cathode section with an insulator, said capacitor elements each having a dielectric oxide film layer, a solid electrolyte layer, and a cathode layer that are sequentially laminated on a surface of the cathode section; an anode comb terminal to which the anode sections of the capacitor elements are integrally connected; a cathode comb terminal to which the cathode sections of the capacitor elements are integrally connected likewise; and an insulative exterior resin entirely covering the capacitor elements with respective parts of the anode comb terminal and the cathode comb terminal exposed on outer surfaces, wherein the anode section and the cathode section of each of the capacitor elements are coupled by resistance welding through a through hole in a joint surface of the anode comb terminal for supporting the anode section of each of the capacitor elements”.

### SUMMARY

At present, there is a demand for further improvement in the volumetric density (capacitance per unit volume) of solid electrolytic capacitors. One object of the present disclosure is to provide a solid electrolytic capacitor having a high volumetric density and a method of producing the same.

One aspect of the present disclosure relates to a production method for a solid electrolytic capacitor. The production method for a solid electrolytic capacitor is a method for producing a solid electrolytic capacitor including at least one solid electrolytic capacitor element including a cathode portion and an anode portion including an anode lead-out portion. The method includes:
a step (i) of connecting an anode connecting member made of a metal that is not a valve metal to the anode lead-out portion of the at least one solid electrolytic capacitor element;
a step (ii) of forming an exterior body to cover the at least one solid electrolytic capacitor element and at least a part of the anode connecting member,
a step (iii) of exposing a surface of a part of the anode connecting member on the exterior body as a connecting surface by removing a part of the exterior body; and
a step (iv) of connecting an anode lead terminal to the connecting surface of the anode connecting member.

Another aspect of the present disclosure relates to a solid electrolytic capacitor. The solid electrolytic capacitor includes:
at least one solid electrolytic capacitor element;
an anode connecting member made of a metal that is not a valve metal;
an exterior body provided to cover the at least one solid electrolytic capacitor element and the anode connecting member; and
an anode lead terminal exposed to an outside, wherein
each of the at least one solid electrolytic capacitor element includes a cathode portion and an anode portion including an anode lead-out portion,
the anode connecting member is connected to the anode lead-out portion,
a part of the surface of the anode connecting member is exposed on the exterior body as a connecting surface, and
the anode lead terminal is connected to the connecting surface of the anode connecting member.

According to the present disclosure, a solid electrolytic capacitor having a high volumetric density can be obtained.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1A schematically illustrates one step of an example of a production method according to a first embodiment.

FIG. 1B schematically illustrates one step subsequent to the step of FIG. 1A.

FIG. 1C schematically illustrates one step subsequent to the step of FIG. 1B.

FIG. 1D schematically illustrates an example of a solid electrolytic capacitor produced using the production method according to the first embodiment.

FIG. 2 schematically illustrates a cross section of an example of a solid electrolytic capacitor element used in the production method according to the first embodiment.

FIG. 3A schematically illustrates an example of the configuration of a connecting surface exposed through a step (iii).

FIG. 3B schematically illustrates an example of a step (iii-b).

FIG. 4 schematically illustrates another example of the solid electrolytic capacitor produced using the production method according to the first embodiment.

FIG. 5A schematically illustrates another example of one step of the producing method according to the first embodiment.

FIG. 5B schematically illustrates another example of the solid electrolytic capacitor produced using the production method according to the first embodiment.

FIG. 6A schematically illustrates one step of a production method according to a second embodiment.

FIG. 6B schematically illustrates an example of a solid electrolytic capacitor produced using the production method according to the second embodiment.

FIG. 7 schematically illustrates a cross section of an example of a solid electrolytic capacitor element used in the production method according to the second embodiment.

### DETAILED DESCRIPTION

Embodiments of the present disclosure are described below by way of examples, but the present disclosure is not limited to the examples described below. In the following description, specific numerical values and materials may be exemplified in some cases, but other numerical values and other materials may be adopted as long as the effects of the present disclosure can be obtained. In the present description, the phrase “a numerical value A to a numerical value B” means to include the numerical value A and the numerical value B, and can be phrased as “a numerical value A or more and a numerical value B or less”. In the following description, when the lower and upper limits of numerical values related to specific physical properties, conditions, or the like are mentioned as examples, any of the mentioned lower limits and any of the mentioned upper limits can be combined in any combination as long as the lower limit is not equal to or more than the upper limit. In the following description, when an example of a component or an example of a method is enumerated, only one of the enumerated examples may be used, or a plurality of the enumerated examples may be used in combination, unless otherwise specified. In the present specification, the configuration in which two members are connected includes a configuration in which two members are directly connected, and a configuration in which two members are connected via a layer or the like. Examples of the layer include conductive layers (such as a solder layer and a metal paste layer).

### (Solid Electrolytic Capacitor Production Method)

A production method of the present embodiment is a production method for a solid electrolytic capacitor including at least one solid electrolytic capacitor element including a cathode portion and an anode portion including an anode lead-out portion. In the following, the production method may be referred to as “production method (M)”. No particular limitations are placed on the solid electrolytic capacitor produced using the production method (M).

The production method (M) includes a step (i), a step (ii), a step (iii), and a step (iv) in this order. These steps will be described later. In the production method (M), the anode lead-out portion and an anode lead terminal are connected via an anode connecting member made of a metal (metal having no valve action) that is not a valve metal. Therefore, connection between the anode connecting member and the anode lead terminal is easy to establish, and the anode connecting member and the anode lead terminal can be firmly connected with high reliability.

When the solid electrolytic capacitor includes a plurality of solid electrolytic capacitor elements, the ends of the anode lead-out portions are connected to an anode connecting member as a group in the step (i). Therefore, production cost and production time can be significantly reduced as compared with a case where each end is connected to a separate anode connecting member.

### Step (i)

The step (i) is a step of connecting an anode connecting member made of a metal (metal having no valve action) that is not a valve metal to the anode lead-out portion of the at least one solid electrolytic capacitor element. Examples of the anode lead-out portion include a part of an anode foil (anode body) and an anode wire, which will be described later.

The metal having a valve action is a metal exhibiting a rectifying property in presence of a relatively stable oxide film formed on the surface thereof. Metals having valve action are called valve metals. Examples of the valve metals include titanium, tantalum, aluminum, and niobium. The metal having no valve action is a metal that is not a valve metal. Examples of metals having no valve action include copper and copper alloys. That is, the metal having no valve action may be at least one selected from the group consisting of copper and a copper alloy, and may be copper or a copper alloy. Copper and copper alloys, which have high conductivity and are easy to connect, are preferred.

No particular limitations are placed on the method of connecting the anode connecting member and the anode lead-out portion, and a known method may be used. Examples of the connection method include connection by welding, connection with a conductive paste, and connection with a solder. Examples of the welding include laser welding, resistance welding, and other welding methods (the same applies to welding described below). The conductive paste may be a mixture of a resin and conductive particles (such as carbon particles or metal particles). The conductive paste may be a metal paste (e.g., a silver paste) containing metal particles.

No particular limitations are placed on the solid electrolytic capacitor element. Examples of the solid electrolytic capacitor element include a capacitor in which an anode portion includes a foil of a valve metal, and a capacitor in which an anode portion includes a sintered body. That is, the anode portion may include a sintered body containing a valve metal.

The solid electrolytic capacitor element may be formed using a known method. The number of solid electrolytic capacitor elements included in the solid electrolytic capacitor may be one or two or more. The upper limit of the number of solid electrolytic capacitor elements included in the solid electrolytic capacitor is not limited, and may be 10 or less. The plurality of solid electrolytic capacitor elements are usually connected in parallel.

The solid electrolytic capacitor may include a plurality of solid electrolytic capacitor elements stacked on top of one another. In this case, in the step (i), the ends of the anode lead-out portions of the plurality of solid electrolytic capacitor elements may be connected to the anode connecting member as a group. For example, when the plurality of anode lead-out portions are formed of metal foils, the ends of the anode lead-out portions may be overlayed and connected to the anode connecting member. The ends of the anode lead-out portions are connected to each other. No particular limitations are placed on the method of connecting these. Examples of the connection method include connection by welding, connection with a metal paste (e.g., a silver paste), and connection with a solder. Alternatively, the ends of the anode lead-out portions may be physically connected using a method such as a method of surrounding a connection part using an anode connecting member.

When the solid electrolytic capacitor includes a plurality of solid electrolytic capacitor elements stacked on top of one another, the anode connecting member may be sandwiched between the plurality of stacked anode lead-out portions, and the cathode connecting member may be sandwiched between the plurality of stacked cathode portions.

### Step (ii)

The step (ii) is a step of forming an exterior body to cover the at least one of the solid electrolytic capacitor element and at least a part of the anode connecting member. No particular limitations are placed on the exterior body and the method of forming the exterior body, and any known exterior body and any known method may be used. Examples of the exterior body will be described later. The exterior body may be formed using a molding technique such as transfer molding, compression molding, or injection molding. The exterior body after the step (ii) includes a part to be an exterior body of the produced solid electrolytic capacitor and a part to be removed in the step (iii).

### Step (iii)

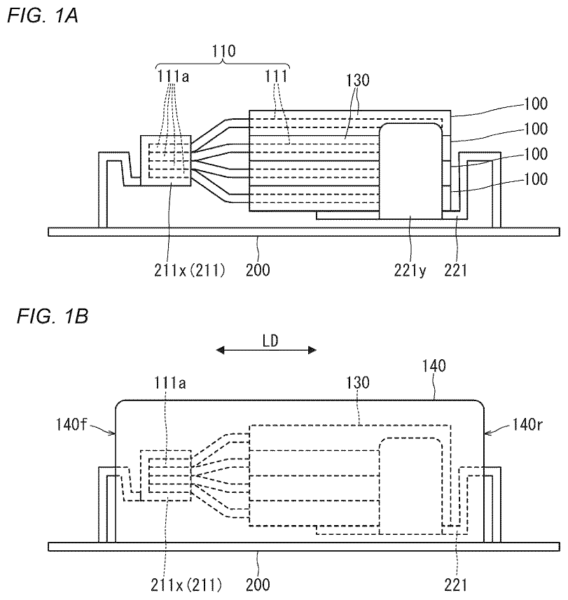

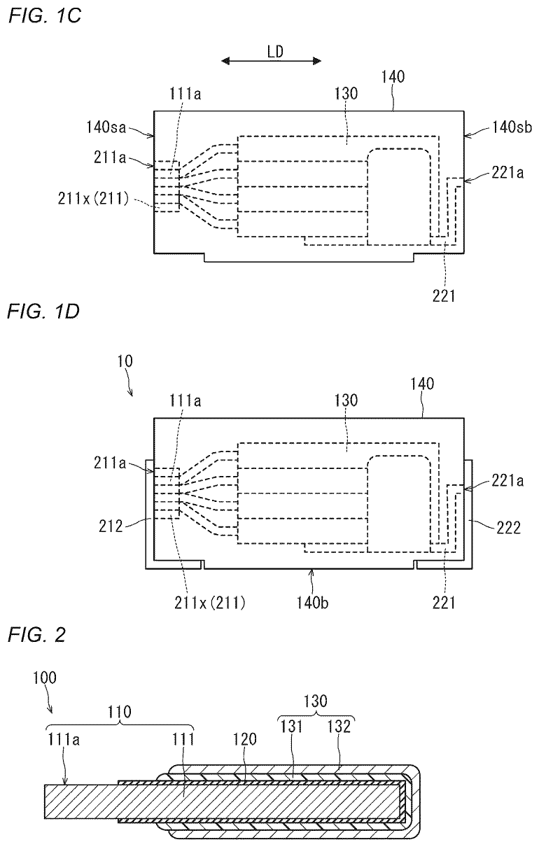

The step (iii) is a step of exposing the surface of a part of the anode connecting member on the exterior body as a connecting surface by removing a part of the exterior body. The step (iii) usually includes a step of cutting a part of the exterior body. As a result of execution of this step (iii), it is possible to reduce the volume of the exterior body and increase the volumetric density without changing the volume of a part thereof that generates capacitance of the solid electrolytic capacitor element. Exterior body removal (e.g., cutting) is performed such that the length of the exterior body in a direction LD (see FIG. 1B) is shortened. For example, the exterior body (and the anode connecting member as necessary) may be cut in a direction perpendicular to the direction LD.

No particular limitations are placed on the method of performing the step of cutting. The step of cutting may be performed using a blade (e.g., a circular blade). For example, the step of cutting may be performed using a dicing blade or the like used for semiconductor wafer cutting. That is, the step of cutting may be performed using a dicer or similar device for semiconductor wafer cutting.

No particular limitations are place on the cutting width. Further, no particular limitations are placed on a distance L between the cathode portion and the cut surface after cutting. The shorter the distance L, the higher the volumetric density.

The step (iii) may include a step (iii-a) of removing a part of the exterior body by cutting the exterior body and the anode connecting member together. Through cutting in the step (iii-a), the surface of a part of the anode connecting member can be exposed on the exterior body as a connecting surface.

The step (iii) may further include a step (iii-b) of causing, after the step (iii-a), a part of the anode connecting member to protrude from the exterior body by removing a part of the exterior body exposed on the cut surface. Protrusion of a part of the anode connecting member from the exterior body can increase the area of the anode connecting member exposed on the exterior body (the area of the contact surface). As a result, establishment of firm connection between the anode connecting member and the anode lead terminal can be facilitated.

No particular limitations are placed on the method of performing the step (iii-b). Examples of the method of performing the step (iii-b) include sandblasting and laser irradiation (such as laser ablation). A length (height) H at which the anode connecting member protrudes from the exterior body through the step (iii-b) may be 50 μm or more, or 100 μm or more. As a result of the length H being set to 50 μm or more, firm connection between the anode connecting member and the anode lead terminal can be made particularly easily. The upper limit of the length H is not particularly limited, and may be 200 μm or less or 150 μm or less from the point of view of production cost and production time.

In performing the step (iii-b), the entirety of the cut surface of the exterior body may be removed, or only a part of the cut surface of the exterior body may be removed. For example, a part of the cut surface of the exterior body may be removed in the shape of a groove. The relationship between the width of the formed groove, the width of the connecting surface, and the width of the anode lead terminal will be described in a first embodiment.

### Step (iv)

The step (iv) is a step of connecting the anode lead terminal and the connecting surface of the anode connecting member. Through the step (iv), the anode portion and the anode lead terminal are electrically connected via the anode connecting member. No particular limitations are placed on the connection method between the anode lead terminal and the connecting surface of the anode connecting member. Examples of the connection method include connection by welding, connection with a metal paste (e.g., a silver paste), and connection with a solder. The anode lead terminal is attached from the outside. That is, the anode lead terminal is exposed to the outside.

No particular limitations are placed on the solder (e.g., a solder paste), and a known lead-free solder may be used. A solder having a high solidus temperature (lead-free solder) may be used for the solder. For example, a solder may be used that does not remelt in a reflow process performed when an electronic component is mounted. Use of such a solder can inhibit occurrence of, for example, disconnection in the reflow process. The solidus temperature of the solder having a high solidus temperature may be 230° C. or higher, or 300° C. or lower. A commercially available solder or a known solder may be used for the solder having a high solidus temperature. Examples of solders having a solidus temperature of 230° C. or higher include Sn—Sb-based Sn-5Sb and Sn-10Sb solders.

The above description describes a step of exposing the surface of a part of the anode connecting member as a connecting surface by removing a part of the exterior body. The production method (M) may further include a step of exposing the surface of a part of the cathode connecting member as a connecting surface by removing a part of the exterior body. Through this step, the volumetric density can be further increased. In this case, the steps (i) to (iv) may be performed as follows. First, the step (i) further includes a step of connecting a cathode connecting member made of a metal (metal having no valve action) that is not a valve metal to the cathode portion. Next, in the step (ii), an exterior body is formed to cover the at least one solid electrolytic capacitor element, at least a part of the anode connecting member, and at least a part of the cathode connecting member. Next, the step (iii) further includes a step of exposing the surface of a part of the cathode connecting member on the exterior body as a connecting surface by removing another part of the exterior body. Next, the step (iv) further includes a step of connecting the cathode lead terminal and the connecting surface of the cathode connecting member.

The method of connecting the cathode connecting member to the cathode portion in the step (i) is not limited, and may be performed using a known method. For example, a metal paste (e.g., a silver paste) may be used to connect the two. The steps (ii) to (iv) can be performed in the same manner as described as the steps (ii) to (iv) regarding the anode connecting member, and therefore duplicate description is omitted. In the step (iv), the cathode lead terminal is attached from the outside. That is, the cathode lead terminal is exposed to the outside.

A solid electrolytic capacitor is obtained using the production method (M). The anode lead terminal and the cathode lead terminal each function as a connection terminal.

### (Solid Electrolytic Capacitor)

Hereinafter, the solid electrolytic capacitor of the present embodiment may be referred to as a “solid electrolytic capacitor (E)”. The solid electrolytic capacitor (E) can be produced using the production method (M). Since the matter described about the production method (M) is applicable to the solid electrolytic capacitor (E), a repetitive description may be omitted. Further, the matter described about the solid electrolytic capacitor (E) may be applied to the production method (M). The solid electrolytic capacitor (E) may be produced using a method other than the production method (M).

The solid electrolytic capacitor (E) includes at least one solid electrolytic capacitor element, an anode connecting member made of a metal (metal having no valve action) that is not a valve metal, an exterior body provided to cover the at least one solid electrolytic capacitor element and the anode connecting member, and an anode lead terminal exposed to the outside. The solid electrolytic capacitor element includes a cathode portion and an anode portion including an anode lead-out portion. The anode connecting member is connected to the anode lead-out portion. The surface of a part of the anode connecting member is exposed on the exterior body as a connecting surface. The connecting surface of the anode connecting member is connected to the anode lead terminal.

According to the solid electrolytic capacitor (E), the volume of the exterior body can be reduced without changing the volume of a portion that generates capacitance of the solid electrolytic capacitor element. Therefore, the volumetric density can be increased.

The solid electrolytic capacitor (E) may include a plurality of solid electrolytic capacitor elements stacked on top of one another. In this case, the ends of the anode lead-out portions of the solid electrolytic capacitor elements may be connected to the anode connecting member as a group.

The anode portion may include a sintered body containing a valve metal. Alternatively, the anode portion may include a foil of a valve metal.

The part of the anode connecting member may protrude from the exterior body. This configuration can be realized through the step (iii-b).

The solid electrolytic capacitor (E) may further include a cathode connecting member covered with the exterior body and made of a metal (metal having no valve action) that is not a valve metal, and a cathode lead terminal exposed to the outside. The cathode connecting member may be connected to the cathode portion. The surface of a part of the cathode connecting member may be exposed on the exterior body as a connecting surface. The connecting surface of the cathode connecting member and the cathode lead terminal may be connected to each other.

The following describes examples of the elements of configuration used in the solid electrolytic capacitor (E) and the production method (M) of the present embodiment. To the elements of configuration used in the solid electrolytic capacitor (E) and the production method (M), elements of configuration of a known solid electrolytic capacitor may be applied except the characteristic elements of the present disclosure.

### (Solid Electrolytic Capacitor Element)

The solid electrolytic capacitor element includes an anode portion, a cathode portion, and a dielectric layer. The cathode portion includes an electrolyte layer, and may further include a cathode extraction layer.

### (Anode Portion)

The anode portion includes an anode lead-out part and an anode body. The anode lead-out portion is electrically connected to the anode body. The anode body can be formed with a valve metal or a metal containing a valve metal.

As the anode body, a metal foil (a foil containing a valve metal or a foil made of a valve metal) may be used. The thickness of the metal foil (anode body) is not particularly limited. The thickness of the metal foil may be, for example, 15 μm or more, or 80 μm or more, and may be 300 μm or less, or 250 μm or less. The surface of at least a part of the metal foil (anode body) may be roughened, for example, by electrolytic etching. In this case, the anode body includes a porous portion on the surface thereof. A preferable example of the anode body that is a metal foil is an aluminum foil. When the anode body is a metal foil, one end of the metal foil may function as the anode lead-out portion.

The anode body may be a sintered body formed by sintering particles as a material. Examples of the particles as a material include particles of a valve metal and particles of an alloy containing a valve metal. A preferable example of the anode body that is a sintered body is a sintered body of tantalum. When the anode body is a sintered body, an anode wire may be used as the anode lead-out portion. One end of the anode wire is embedded in the sintered body, and the other end protrudes from the end surface of the sintered body.

### (Dielectric Layer)

The dielectric layer is formed on at least a portion of the surface of the anode body. The dielectric layer may be formed, for example, by anodizing (anodization by chemical conversion treatment) the surface of the anode body. In this case, the dielectric layer contains an oxide of a valve metal. For example, when aluminum is used as the valve metal, the dielectric layer may contain aluminum oxide. When a porous portion is present on the surface of the anode body, the dielectric layer may be formed on at least a part of the surface of the porous portion of the anode body.

### (Cathode Portion)

The cathode portion includes an electrolyte layer and a conductive layer adjacent to the electrolyte layer. The conductive layer should be formed to cover at least a part of the electrolyte layer, and may be formed to cover the entire surface of the electrolyte layer. Examples of the conductive layer include a carbon-containing layer and a metal-containing layer. The metal-containing layer can be formed of a metal paste (e.g., a silver paste). The conductive layer may include a carbon-containing layer formed on the electrolyte layer, and a metal-containing layer (e.g., a silver-containing layer) formed on the carbon-containing layer.

### (Electrolyte Layer)

The electrolyte layer (solid electrolyte layer) is provided to cover at least a part of the dielectric layer. The electrolyte layer contains a manganese compound or a conductive polymer, for example. Examples of the conductive polymer include polypyrrole, polythiophene, polyfuran, polyaniline, polyacetylene, polyphenylene, polyphenylene vinylene, polyacene, polythiophene vinylene, and derivatives of these. A preferable example of the conductive polymer is poly (3,4-ethylenedioxythiophene).

The conductive polymer may be contained in the solid electrolyte layer together with a dopant. A preferable example of the dopant is a polymeric anion derived from polystyrene sulfonic acid. A preferable example of the electrolyte layer is a layer formed using poly (3,4-ethylenedioxythiophene) (PEDOT) doped with polystyrenesulfonic acid (PSS).

### (Anode Connecting Member and Cathode Connecting Member)

The anode connecting member and the cathode connecting member can each be formed of a metal (e.g., copper or a copper alloy) that is not a valve metal. The thickness of the anode connecting member and the thickness of the cathode connecting member may each be in the range of 25 μm to 200 μm (e.g., in the range of 25 μm to 100 μm). For forming the anode connecting member or the cathode connecting member, a thin metal sheet used for known lead terminals may be used.

### (Exterior Body)

No limitations are placed on the exterior body, and a known exterior body may be used. The exterior body contains an exterior resin. Examples of the exterior resin include a curable resin and an engineering plastic. Examples of the curable resin (e.g., thermosetting resin) include epoxy resin, phenolic resin, silicone resin, melamine resin, urea resin, alkyd resin, polyurethane, and unsaturated polyester. Examples of the engineering plastic include general-purpose engineering plastics and super engineering plastics. Examples of the engineering plastics include polyimide and polyamide imide.

In addition to the exterior resin, the exterior body may contain another additive such as an inorganic filler. That is, at least a part of the exterior body may be constituted by a resin composition. Examples of the inorganic filler include silica (e.g., fused silica), talc, calcium carbonate, and aluminum oxide.

Examples of embodiments according to the present disclosure will be specifically described below with reference to the drawings. The examples described below can be altered based on the above description. Further, the matter described below may be applied to the above-described embodiment. In the embodiments described below, any elements of configuration that are not essential to the solid electrolytic capacitor of the present disclosure may be omitted. In order to facilitate understanding, some of the members are not illustrated in the drawings mentioned below.

### First Embodiment

In a first embodiment, a method of producing a solid electrolytic capacitor including a plurality of solid electrolytic capacitor elements will be described as an example.

First, a plurality of solid electrolytic capacitor elements 100 are stacked and connected to an anode connecting member 211 and a cathode connecting member 221 (step (i)) as illustrated in FIG. 1A. The step (i) may be performed using a method similar to a known method in which a plurality of solid electrolytic capacitor elements 100 are stacked and connected to an anode lead terminal and a cathode lead terminal. The anode connecting member 211 and the cathode connecting member 221 are connected to a sheet 200. The anode connecting member 211 and the cathode connecting member 221 can be formed by cutting and bending a part of the sheet 200. The sheet 200 is a sheet made of a metal (metal having no valve action) that is not a valve metal.

The anode connecting member 211 includes a portion 211x surrounding a plurality of stacked anode lead-out portions 111a. The cathode connecting member 221 includes two side walls 221y arranged to sandwich the side surfaces of the plurality of stacked solid electrolytic capacitor elements 100. However, the shapes of the anode connecting member 211 and the cathode connecting member 221 may be shapes other than those illustrated in FIG. 1A.

FIG. 2 schematically illustrates a cross-sectional view of an example of one of the solid electrolytic capacitor elements 100. Each solid electrolytic capacitor element 100 includes an anode portion 110 including an anode body (anode foil) 111 and an anode lead-out portion 111a, a dielectric layer 120 covering at least a part of the anode body 111, and a cathode portion 130 covering at least a part of the dielectric layer 120. The cathode portion 130 includes an electrolyte layer (solid electrolyte layer) 131 covering at least a part of the dielectric layer 120, and a conductive layer 132 formed on the electrolyte layer 131.

The conductive layers 132 of the plurality of stacked solid electrolytic capacitor elements 100 are connected to each other. At least one of the conductive layers 132 is connected to the cathode connecting member 221, for example, with a metal paste. One end of the metal foil constituting the anode body 111 functions as the anode lead-out portion 111a. The anode lead-out portions 111a of the plurality of solid electrolytic capacitor elements 100 are overlapped and connected to each other. At least one of the anode lead-out portions 111a is connected to the anode connecting member 211, for example, by welding.

Next, an exterior body 140 is formed to cover the solid electrolytic capacitor elements 100, at least a part of the anode connecting member 211, and at least a part of the cathode connecting member 221 (Step (ii)) as illustrated in FIG. 1B. In FIG. 1B, a surface of the surfaces of the exterior body 140 located at the end surfaces of the anode lead-out portions 111a of the solid electrolytic capacitor elements 100 is referred to as a front surface 140f, and a surface thereof located opposite to the front surface 140f is referred to as a rear surface 140r. A direction connecting the front 140f and the rear 140r is defined as a direction LD.

Next, a part of the exterior body 140 is removed to expose the surface of a part of the anode connecting member 211 on the exterior body 140 as a connecting surface 211 (step (iii)) as illustrated in FIG. 1C. Further, by removing another part of the exterior body 140, the surface of a part of the cathode connecting member 221 is exposed on the exterior body 140 as a connecting surface 221a. The part of the exterior body is removed by cutting the exterior body 140 and the anode connecting member 211 together. The other part of the exterior body is removed by cutting the exterior body 140 and the cathode connecting member 221 together. Each cutting is performed such that the length of the exterior body 140 in the directional LD is shortened. The cutting forms cut surfaces 140sa and a 140sb. The connecting surface 211a is exposed on the cut surface 140sa, and the connecting surface 221a is exposed on the cut surface 140sb.

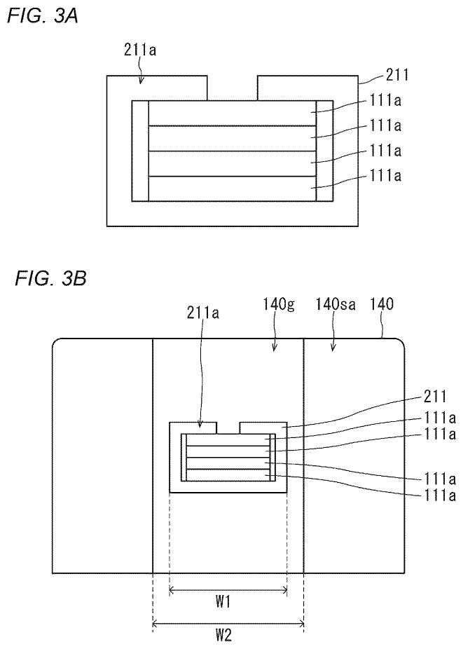

One example of the connecting surface (end surface) 211a of the anode connecting member 211 exposed through the step (iii) is illustrated in FIG. 3A. The connecting surface 211a illustrated in FIG. 3A is C-shaped in cross section and has a configuration in which the overlapped anode lead-out portions 111a are surrounded. The connecting surface 211a such as above can be formed by bending the anode connecting member 211 into a substantially cylindrical shape in the step (i). Thus, the anode lead-out portions 111a and the anode connecting member 211 can be firmly fixed. Note that the shape of the connecting surface 211a is not limited to the shape illustrated in FIG. 3A, and may be substantially linear or may be substantially U-shaped. The shape of the connecting surface 221a varies according to the shape of the anode connecting member 211 in the step (i).

In performing the above-described step (iii-b), the entire surface of the exterior body 140 on the cut surface 140sa (or the cut surface 140sb) may be removed. Alternatively, only a part of the surface of the exterior body 140 on the cut surface 140sa (or the cut surface 140sb) may be removed. One example where only a part of the surface of the exterior body 140 on the cut surface 140sa is removed is illustrated in FIG. 3B. In the example illustrated in 3B, a part of the surface of the exterior body 140 on the cut surface 140sa is removed in a groove shape to form a groove 140g. A width W2 of the groove 140g may be larger than a width W1 of the connecting surface 211a, and may be a width into which the anode lead terminal 212 can enter. Specifically, the width W2 may be equal to or slightly larger than the width of the anode lead terminal 212. In the above configuration, a part of the anode lead terminal 212 can be fitted into the groove 140g, so that the connection between the anode lead terminal 212 and the connecting surface 211a can be easily established. Further, connection between the anode lead terminal 212 and the connecting surface 211a is stabilized. Note that the width of the anode lead terminal 212 is larger than the width of the connecting surface 211a, and the anode lead terminal 212 covers the entirety of the connecting surface 211a.

Next, the anode lead terminal 212 and the connecting surface 211a of the anode connecting member 211 are connected (step (iv)) as illustrated in FIG. 1D. Similarly, the cathode lead terminal 222 and the connecting surface 221a of the cathode connecting member 221 are connected. The anode lead terminal 212 and the cathode lead terminal 222 are exposed to the outside. That is, they are exposed on the exterior body 140. A part of the anode lead terminal 212 and a part of the cathode lead terminal 222 are arranged on the bottom surface 140b of the exterior body 140. These parts can function as terminals when the produced solid electrolytic capacitor 10 is mounted, for example, on a printed circuit board. The anode lead terminal 212 and the cathode lead terminal 222 may be connected in an L-shape to the respective connecting surfaces. Alternatively, the anode lead terminal 212 and the cathode lead terminal 222 may be bent after connection to the respective connecting surfaces.

Since the anode lead-out portion 111a contains a valve metal, a relatively stable native oxide film is formed on the surface thereof. This makes it relatively difficult to connect the anode lead terminal 212 and the anode lead-out portion 111a. By contrast, connection between the anode lead terminal 212 and the anode connecting member 211 can be easily and reliably done. Of course, the anode lead terminal 212 and the anode lead-out portion 111a may be connected during connection between the anode lead terminal 212 and the anode connecting member 211. The above descriptions also apply to connection on the side of the cathode portion 130.

In the manner described above, the solid electrolytic capacitor 10 is obtained. In the solid electrolytic capacitor 10, the connecting surface 211a of the anode connecting member 211 is covered with the anode lead terminal 212, but is exposed on the exterior body 140. Similarly, the connecting surface 221a of the cathode connecting member 221 is covered with the cathode lead terminal 222, but is exposed on the exterior body 140.

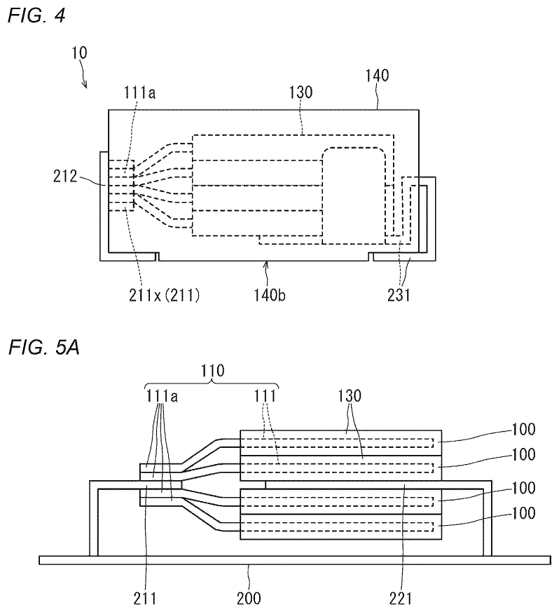

In the above example, an example in which the side of the cathode connecting member 221 is also cut has been described. However, the side of the cathode connecting member 221 may not be cut. In this case, the cathode connecting member is used as a lead terminal 231 on the cathode side without being cut. An example of the solid electrolytic capacitor 10 in this case is schematically illustrated in FIG. 4.

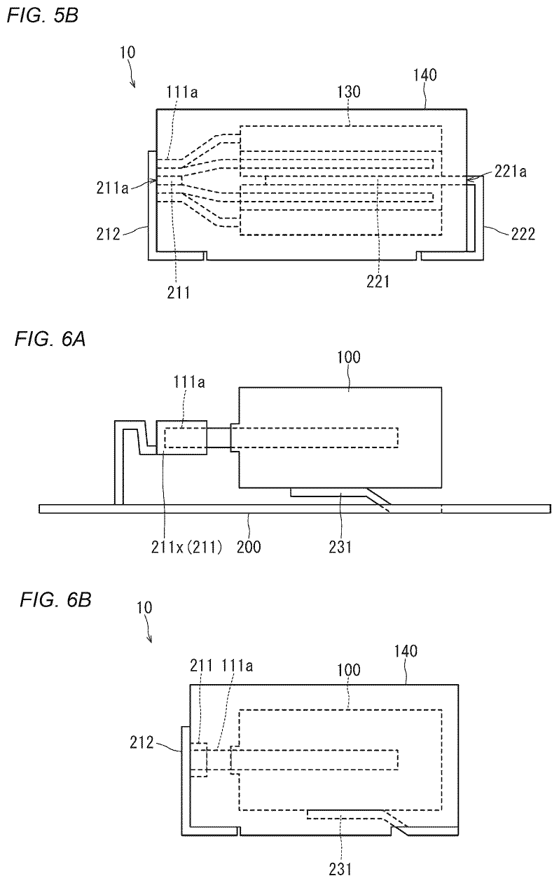

In the above-described production method, the anode connecting member 211 may be sandwiched between the ends of the plurality of stacked anode lead-out portions 111a, and the cathode connecting member 221 may be sandwiched between the plurality of stacked cathode portions 130. FIG. 5A schematically illustrates the state after completion of the step (i) in such a case. Further, the solid electrolytic capacitor 10 finally obtained is schematically illustrated in FIG. 1 5B. As illustrated in FIGS. 5A and 5B, the anode connecting member 211 is sandwiched between the plurality of stacked anode lead-out portions 111a. The cathode connecting member 221 is sandwiched between the plurality of stacked cathode portions 130.

### Second Embodiment

In a second embodiment, another example of the production method for a solid electrolytic capacitor including a solid electrolytic capacitor element will be described. In the solid electrolytic capacitor element used in the second embodiment, the anode body is a sintered body. The solid electrolytic capacitor of the second embodiment includes one solid electrolytic capacitor element.

First, one solid electrolytic capacitor element 100 is connected to an anode connecting member 211 and the lead terminal 231 on the cathode side (Step (i)) as illustrated in FIG. 6A. The second embodiment describes an example in which only the side of the anode connecting member 211 is cut. However, similarly to the first embodiment, the cathode connecting member may be connected to the solid electrolytic capacitor element 100, and both the part on the side of the anode connecting member 211 and the part on the side of the cathode connecting member may be cut. In this case, as described above, the cathode lead terminal is connected to the connecting surface of the cathode connecting member exposed through cutting.

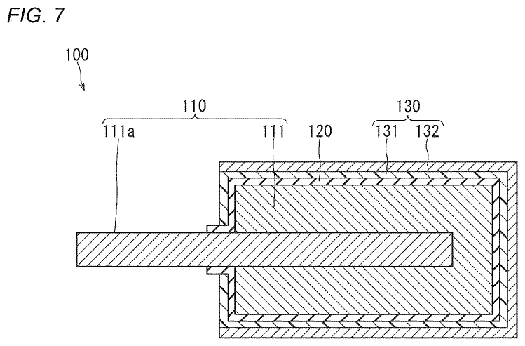

FIG. 7 schematically illustrates a cross-sectional view of an example of the solid electrolytic capacitor element 100. The solid electrolytic capacitor 100 includes an anode portion 110 including an anode body (sintered body) 111 and an anode lead-out portion (anode wire) 111a, a dielectric layer 120 covering at least a part of the anode body 111, and a cathode portion 130 covering at least a part of the dielectric layer 120. The cathode portion 130 includes an electrolyte layer 131 covering at least a part of the dielectric layer 120, and a conductive layer 132 formed on the electrolyte layer 131.

The conductive layer 132 is connected to the lead terminal 231 on the cathode side, for example, with a metal paste. One end of the anode lead-out portion 111a is embedded in the anode body 111. The other end of the anode lead-out portion 111a is connected to the anode connecting member 211, for example, by welding.

Next, the steps (ii) to (iv) are performed in the same manner as in the first embodiment, except that the side of the cathode connecting member is not cut. In the manner described above, the solid electrolytic capacitor 10 illustrated in FIG. 6B is obtained.

### Supplementary Remarks

The above description discloses the following techniques.

### Technique 1

A production method for a solid electrolytic capacitor including at least one solid electrolytic capacitor element including a cathode portion and an anode portion including an anode lead-out portion, the method comprising:
a step (i) of connecting an anode connecting member made of a metal that is not a valve metal to the anode lead-out portion of the at least one solid electrolytic capacitor element;
a step (ii) of forming an exterior body to cover the at least one solid electrolytic capacitor element and at least a part of the anode connecting member,
a step (iii) of exposing a surface of a part of the anode connecting member on the exterior body as a connecting surface by removing a part of the exterior body; and
a step (iv) of connecting an anode lead terminal to the connecting surface of the anode connecting member.

### Technique 2

The production method according to Technique 1, wherein
the solid electrolytic capacitor includes a plurality of the solid electrolytic capacitor elements stacked on top of one another, and
in the step (i), ends of the anode lead-out portions of the plurality of stacked solid electrolytic capacitor elements are connected to the anode connecting member as a group.

### Technique 3

The method according to Technique 1 or 2, wherein the anode portion includes a sintered body containing a valve metal.

### Technique 4

The production method according to any one of Techniques 1 to 3, wherein the step (iii) includes a step (iii-a) of removing the part of the exterior body by cutting the exterior body and the anode connecting member together.

### Technique 5

The production method according to Technique 4, wherein the step (iii) further includes a step (iii-b) of causing, after the step (iii-a), the part of the anode connecting member to protrude from the exterior body by removing a part of the exterior body exposed on a cut surface.

### Technique 6

The production method according to any one of Techniques 1 to 5, wherein
the step (i) further includes a step of connecting a cathode connecting member made of a metal that is not a valve metal to the cathode portion,
in the step (ii), the exterior body is formed to cover the at least one solid electrolytic capacitor element, at least a part of the anode connecting member, and at least a part of the cathode connecting member,
the step (iii) further includes a step of exposing a surface of a part of the cathode connecting member on the exterior body as a connecting surface by removing another part of the exterior body, and
the step (iv) further includes a step of connecting a cathode lead terminal to the connecting surface of the cathode connecting member.

### Technique 7

A solid electrolytic capacitor including:
at least one solid electrolytic capacitor element;
an anode connecting member made of a metal that is not a valve metal;
an exterior body provided to cover the at least one solid electrolytic capacitor element and the anode connecting member; and
an anode lead terminal exposed to an outside, wherein
each of the at least one solid electrolytic capacitor element includes a cathode portion and an anode portion including an anode lead-out portion,
the anode connecting member is connected to the anode lead-out portion,
a part of the surface of the anode connecting member is exposed on the exterior body as a connecting surface, and
the anode lead terminal is connected to the connecting surface of the anode connecting member.

### Technique 8

The solid electrolytic capacitor according to Technique 7, including a plurality of the solid electrolytic capacitor elements stacked on top of one another, wherein
ends of the anode lead-out portions of the plurality of stacked solid electrolytic capacitor elements are connected to the anode connecting member as a group.

### Technique 9

The solid electrolytic capacitor according to Technique 7 or 8, wherein the anode portion includes a sintered body containing a valve metal.

### Technique 10

The solid electrolytic capacitor according to any one of Techniques 7 to 9, wherein the part of the anode connecting member protrudes from the exterior body.

### Technique 11

The solid electrolytic capacitor according to any one of Techniques 7 to 10, further including a cathode connecting member that is covered with the exterior body and that is made of a metal that is not a valve metal; and a cathode lead terminal exposed to an outside, wherein
the cathode connecting member is connected to the cathode portion, a surface of a part of the cathode connecting member is exposed on the exterior body as a connecting surface, and
the cathode lead terminal is connected to the connecting surface of the cathode connecting member.

The present disclosure is applicable to a solid electrolytic capacitor.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted to cover all alterations and modifications as fall within the true spirit and scope of the invention.

### REFERENCE SIGNS LIST

10: Solid electrolytic capacitor
100: Solid electrolytic capacitor element
110: Anode portion
111: Anode body
111a: Anode lead-out portion
130: Cathode portion
140: Exterior body
211: Anode connecting member
211a: Connecting surface
212: Anode lead terminal
221: Cathode connecting member
221a: Connecting surface
222: Cathode lead terminal
231: Lead terminal

What is claimed is:

1. A production method for a solid electrolytic capacitor including at least one solid electrolytic capacitor element including a cathode portion and an anode portion including an anode lead-out portion, the method comprising:
a step (i) of connecting an anode connecting member made of a metal that is not a valve metal to the anode lead-out portion of the at least one solid electrolytic capacitor element;
a step (ii) of forming an exterior body to cover the at least one solid electrolytic capacitor element and at least a part of the anode connecting member,
a step (iii) of exposing a surface of a part of the anode connecting member on the exterior body as a connecting surface by removing a part of the exterior body; and
a step (iv) of connecting an anode lead terminal to the connecting surface of the anode connecting member.

2. The production method according to claim 1, wherein
the solid electrolytic capacitor includes a plurality of the solid electrolytic capacitor elements stacked on top of one another, and
in the step (i), ends of the anode lead-out portions of the plurality of stacked solid electrolytic capacitor elements are connected to the anode connecting member as a group.

3. The production method according to claim 1, wherein
the anode portion includes a sintered body containing a valve metal.

4. The production method according to claim 1, wherein
the step (iii) includes a step (iii-a) of removing the part of the exterior body by cutting the exterior body and the anode connecting member together.

5. The production method according to claim 4, wherein
the step (iii) further includes a step (iii-b) of causing, after the step (iii-a), the part of the anode connecting member to protrude from the exterior body by removing a part of the exterior body exposed on a cut surface.

6. The production method according to claim 1, wherein
the step (i) further includes a step of connecting a cathode connecting member made of a metal that is not a valve metal to the cathode portion,
in the step (ii), the exterior body is formed to cover the at least one solid electrolytic capacitor element, at least a part of the anode connecting member, and at least a part of the cathode connecting member,
the step (iii) further includes a step of exposing a surface of a part of the cathode connecting member on the exterior body as a connecting surface by removing another part of the exterior body, and
the step (iv) further includes a step of connecting a cathode lead terminal to the connecting surface of the cathode connecting member.

7. A solid electrolytic capacitor comprising:
at least one solid electrolytic capacitor element;
an anode connecting member made of a metal that is not a valve metal;
an exterior body provided to cover the at least one solid electrolytic capacitor element and the anode connecting member; and
an anode lead terminal exposed to an outside, wherein
each of the at least one solid electrolytic capacitor element includes a cathode portion and an anode portion including an anode lead-out portion,
the anode connecting member is connected to the anode lead-out portion,
a part of the surface of the anode connecting member is exposed on the exterior body as a connecting surface, and
the anode lead terminal is connected to the connecting surface of the anode connecting member.

8. The solid electrolytic capacitor according to claim 7, comprising
a plurality of the solid electrolytic capacitor elements stacked on top of one another, wherein
ends of the anode lead-out portions of the plurality of stacked solid electrolytic capacitor elements are connected to the anode connecting member as a group.

9. The solid electrolytic capacitor according to claim 7, wherein
the anode portion includes a sintered body containing a valve metal.

10. The solid electrolytic capacitor according to claim 7, wherein
the part of the anode connecting member protrudes from the exterior body.

11. The solid electrolytic capacitor according to claim 7, further comprising:
a cathode connecting member that is covered with the exterior body and that is made of a metal that is not a valve metal; and
a cathode lead terminal exposed to an outside, wherein
the cathode connecting member is connected to the cathode portion,
a surface of a part of the cathode connecting member is exposed on the exterior body as a connecting surface, and
the cathode lead terminal is connected to the connecting surface of the cathode connecting member.
